(19) United States
(12) Patent Application Publication
(10) Pub. No.: US 2009/0154769 A1
(43) Pub. Date: Jun. 18, 2009

(54) Moving robot and moving object detecting method and medium thereof

(75) Inventors: Sukjune Yoon, Seoul (KR); Seung Ki Min, Suwon-si (KR); Kyung Shik Roh, Seongnam-si (KR); Chil Woo Lee, Gwangju (KR); Chi Min Oh, Gwangju (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRONICS CO., LTD., Suwon-si (KR)

(21) Appl. No.: 12/153,530

(22) Filed: May 20, 2008

(30) Foreign Application Priority Data
Dec. 13, 2007 (KR) 10-2007-130351

(51) Int. Cl. G06K 9/00; H04N 7/18

(52) U.S. Cl. 382/103; 382/107; 382/153; 348/36; 901/46; 348/E07.086

(57) ABSTRACT

A moving robot and moving object detecting method and medium thereof is disclosed. The moving object detecting method includes transforming an omni-directional image captured in the moving robot to a panoramic image, comparing the panoramic image with a previous panoramic image and estimating a movement region of the moving object based on the comparison, and recognizing that a movement of the moving object exist in the estimated movement region when the area of the estimated movement region exceeds the reference area.

### CROSS-REFERENCE TO RELATED APPLICATIONS

This application claims the benefit of Korean Patent Application No. 2007-130351, filed on Dec. 13, 2007 in the Korean Intellectual Property Office, the disclosure of which is incorporated herein by reference.

### BACKGROUND

1. Field

Embodiments of the present invention relate to robots, and, more particularly, to a moving robot that detects a moving object regardless of its movement, and a moving object detecting method and medium thereof.

2. Description of the Related Art

Omni-directional cameras refer to cameras that can acquire a 360° image therearound. In recent years, technology has been introduced where the omni-directional camera is mounted on a moving robot so that the moving robot can detect a moving object using the omni-directional image captured by the omni-directional camera.

A conventional moving robot mounts an omni-directional vision sensor with an omni-directional field of view thereon. The conventional moving robot moves along a particular path and acquires its peripheral images through the omni-directional vision sensor. The conventional moving robot matches the acquired image with several dispersed feature points of the old image previously acquired and then detects the movement of a moving object.

However, since the conventional moving object detecting method tracks regions of several dispersed feature points in an image without taking the movement of robot into consideration and then estimates a movement of an object, it cannot effectively detect the moving object.

Also, since the conventional moving robot used for observation does not set the size of a moving object to be observed, it detects all moving objects including the moving object to be observed. Therefore, the conventional moving robot and its moving object detecting method cannot differentiate a moving object according to a purpose.

### SUMMARY

Therefore, it is an aspect of embodiments of the present invention to provide a moving robot and a moving object detecting method and medium thereof that can precisely detect a moving object regardless of the movement of the moving robot.

It is another aspect of embodiments of the present invention to provide a moving robot and a moving object detecting method and medium thereof that can detect moving objects according to the sizes of the moving objects when the moving robot is used for observation.

Additional aspects and/or advantages of embodiments of the present invention will be set forth in part in the description which follows and, in part, will be obvious from the description, or may be learned by practice of the invention.

In accordance with an aspect of embodiments of the present invention, there is provided a moving object detecting method of a moving robot including transforming an omni-directional image captured in the moving robot to a panoramic image, comparing the panoramic image with a previous panoramic image and estimating a movement region of the moving object based on the comparison, and recognizing that a movement of the moving object exists in the estimated movement region when the area of the estimated movement region exceeds the reference area.

Preferably, the comparing the panoramic image with a previous panoramic image comprises optical flow matching.

Preferably, the optical flow matching includes dividing the previous panoramic image into a plurality of blocks, setting feature points in the plurality of blocks, and determining which location of the current panoramic image the feature points are moved.

Preferably, the feature point is the darkest pixel of the corner pixels of the blocks.

Preferably, the method further includes calculating a sum of absolute difference (SAD) between the blocks matched by the optical flow matching.

Preferably, the method further includes estimating a block is a movement region of a moving object when the SAD is greater than the reference value.

Preferably, the reference area is proportional to the size of a human body.

In accordance with another aspect of embodiments of the present invention, there is provided a moving object detecting method of a moving robot including transforming a plurality of omni-directional images captured in the moving robot to a plurality of panoramic images, comparing the plurality of panoramic images with each other and discovering a block from one of the plurality of panoramic images, wherein the block is matched with a block of another panoramic image; calculating an SAD between the matched blocks, and detecting a moving object using the calculated SAD.

Preferably, the plurality of omni-directional images are two successive images.

Preferably, the method further includes determining that the moving object exists in a unit area, when an area of blocks, which are located in the unit area and between which the SAD is greater than the reference value, exceeds the reference area.

Preferably, the reference area is proportional to the size of the moving object.

Preferably, the moving object includes a human body.

In accordance with another aspect of embodiments of the present invention, there is provided a moving robot including an image processor to transform an omni-directional image to a panoramic image, a memory to store the panoramic image, and a controller to compare the panoramic image transformed in the image processor with a panoramic image previously stored in the memory, to estimate a movement region of a moving object based on the comparison, and to determine that the moving object exists in the estimated movement region when the area of the estimated movement region exceeds a reference area.

Preferably, the controller compares the panoramic image transformed in the image processor with a panoramic image previously stored in the memory using optical flow matching.

Preferably, the reference area is proportional to the size of a moving object to be detected.

In accordance with another aspect of embodiments of the present invention, there is provided a motion detection method including receiving a current panoramic image and a previous panoramic image, matching blocks between the current panoramic image and the previous panoramic image, acquiring an SAD for each of the matching blocks, maintaining a reference SAD and determining motion based on a whether the SAD of a matched block meets the value of a reference SAD.

The matching may be performed by optical flow matching.

The maintaining may be performed by updating the reference SAD value to be a SAD value of a background shared by the current panoramic image and the previous panoramic image.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is an outside view of a moving robot according to an embodiment of the present invention;

FIG. 2 is a cross-sectional view illustrating an omni-directional camera mounted on the moving robot according to an embodiment of the present invention, of FIG. 1, for example;

FIG. 3 is an example of an omni-directional image captured by the omni-directional camera according to an embodiment of the present invention, of FIG. 2, for example;

FIG. 4 is a schematic block diagram illustrating a moving robot according to an embodiment of the present invention;

FIG. 5 is a view illustrating a panoramic image transformed from the omni-direction image according to an embodiment of the present invention, of FIG. 3, for example; and

FIG. 6 is a flow chart describing a moving object detecting method of a moving robot according to an embodiment of the present invention.

### DETAILED DESCRIPTION OF THE EMBODIMENTS

Reference will now be made in detail to the embodiments of the present invention, examples of which are illustrated in the accompanying drawings, wherein like reference numerals refer to the like elements throughout. The embodiments are described below to explain the present invention by referring to the figures.

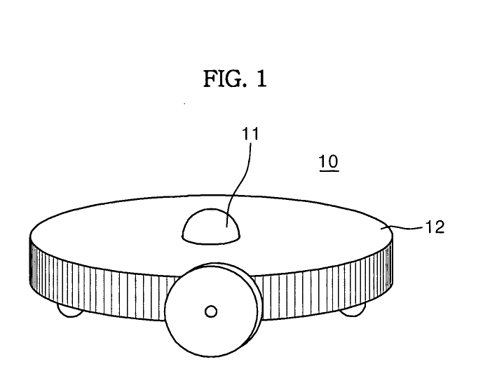

As shown in FIG. 1, the moving robot 10 adapted to an embodiment of the present invention includes a robot body 12 and an omni-directional camera 11 mounted onto the robot body 12.

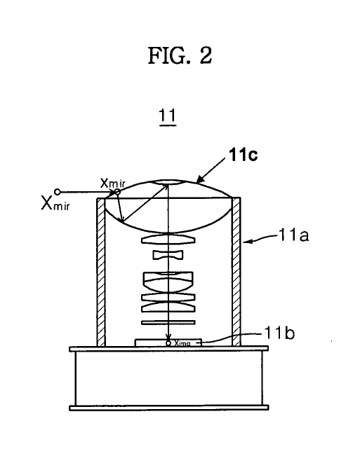

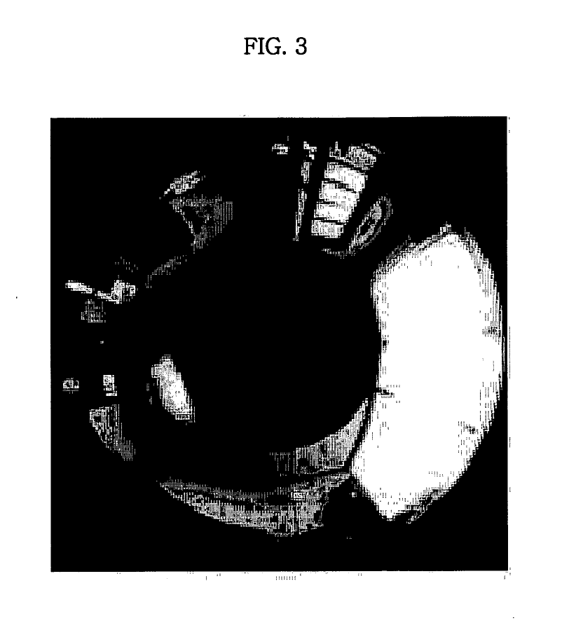

The omni-directional camera 11, as shown in FIG. 2, is configured to include an omni-directional lens 11a and a CCD device 11b. The omni-directional camera 11 further includes a curved mirror 11c mounted at its front portion, which assists the omni-directional camera 11 to acquire a 360° image therearound, as shown in FIG. 3. That is, a spatial point, Xmir, is reflected at a point on the curved mirror, xmir, and then imaged on the CCD device 11b. As a result, the spatial point, Xmir, is shown as a point ximg on an image. Since the spatial point Xmir is dispersed in the omni-direction, the omni-directional camera acquires a 360° image.

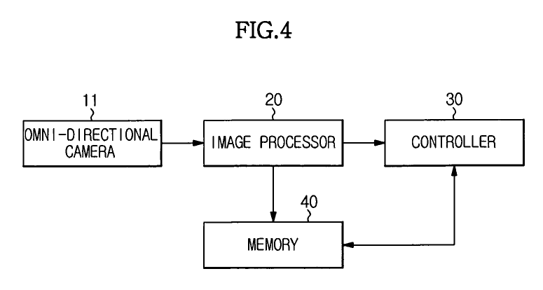

As shown in FIG. 4, the moving robot 10 further includes an image processor 20 to input an image captured by the omni-directional camera 11 and to generate a panoramic image, a controller 30 to recognize a moving object using the panoramic image, and a memory 40 to store the panoramic image.

FIG. 3 shows an omni-directional image of 360° that is captured by the omni-directional camera 11 and is represented in the spherical coordinate system. Because omni-directional images may be represented in the spherical coordinate system, methods using omni-directional images may encounter difficulties when observing an object. Especially, when an omni-directional image, as it is, is used to detect movement of an object, it causes an image distortion phenomenon, such as the captured image being curved, for example. Therefore, an operation is needed that transforms the omni-directional image represented in the spherical coordinate system to a panoramic image represented in a perspective coordinate system. Accordingly, this transformation operation is performed in the image processor 20.

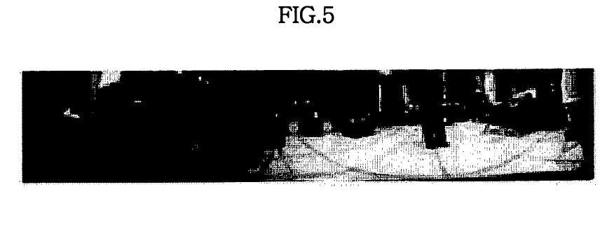

The image processor 20 may have a position transformation look-up table (LUT) for transforming a spherical coordinate system to a perspective coordinate system. That is, the image processor 20 inputs an omni-directional image represented in the spherical coordinate system from the omni-directional camera 11, and transforms it to a panoramic image represented in the perspective coordinate system, as shown in FIG. 5, using the LUT. Since this image transforming operation was disclosed in Korean Patent Publication No. 10-2002-0028853, the present application will omit the detailed description.

The panoramic image generated in the image processor 20 may be stored in the memory 40. The controller 30 detects a movement of a moving object using a panoramic image previously stored in the memory 40, which is hereinafter referred to as a ‘T−1 image,’ and a panoramic image currently transmitted from the image processor 20, which is hereinafter referred to as a ‘T image.’

The moving robot 10 may operate in two modes, such as a plane motion and a rotational motion, individually or simultaneously. When the moving robot 10 moves in a place where there is no movement of an object, its omni-directional camera 11 captures different background images, depending on time. For example, when the moving robot 10 moves in a plane at any one of directions, front, rear, left and right, the T image is partially extended or reduced with respect to the T−1 image. That is, when the moving robot 10 is moved in a plane, the static object in the background is captured with magnification or reduction and thus does not exist at the same location in the two successively captured images, T−1 and T images. In addition, when the moving robot 10 rotates with respect to a certain point, the static object moves in parallel to the right or left in the two images, according to the rotation direction of the moving robot 10. Furthermore, when the moving robot 10 simultaneously rotates and moves, the static object is detected as if the static object had been moving since the captured static object is moved, magnified or reduced.

The controller 30 may perform an optical flow matching operation to resolve an optical illusion as if the static object had moved according to the movement of the moving robot 10.

An optical flow matching operation creates a representation, through vectors, of external movements between two successively captured images of the same background scene. Accordingly, an optical flow matching operation may be performed by: dividing a previously captured image into a plurality of blocks; setting feature points in the respective blocks; and tracking which location of the currently captured image the feature points are moved. Here, the feature point is set to the darkest pixel of the corner pixels in the respective blocks.

When tracking via the optical flow matching operation, to which location of the T image the feature points of respective blocks in the T−1 image are moved, the controller 30 may acquire a sum of absolute difference (SAD) of blocks matched between the T−1 and T images and then checks the movement of an object.

A block where a moving object is moved has a larger SAD than a block where there is no movement of a moving object. However, when the moving robot 10 is moved, the static background is also moved, magnified, or reduced, and thus SAD of the blocks in the static background image is also increased.

The controller 30 may have a reference value of an SAD. When a block has an SAD greater than the reference value of an SAD, the controller 30 estimates the block is a movement region of a moving object. Also, the controller 30 has a reference area proportional to an area of a human body, so that a movement region of a static background, caused by the movement of the moving robot 10, can be removed from the estimated movement region of a moving object. When the area of the blocks between which the SAD exceeds the reference value, located in the unit area, is greater than the reference area, the controller 30 concludes that the moving object is within the unit area.

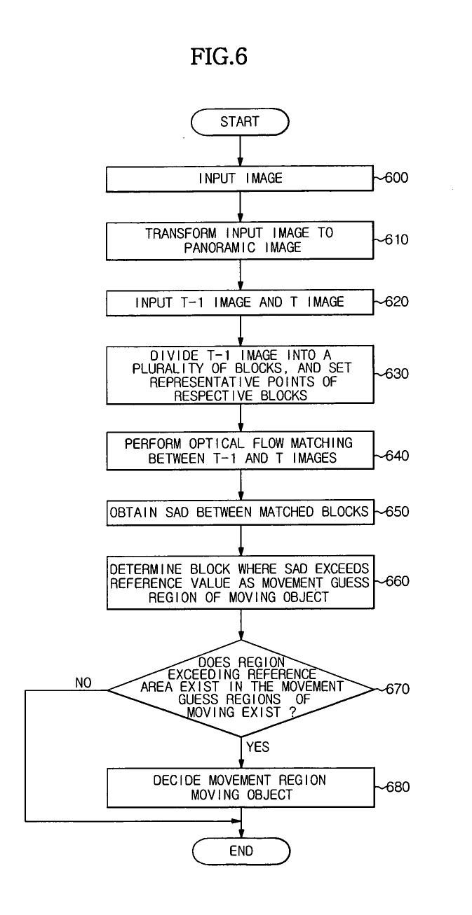

In the following description, a moving object detecting method of a moving robot according to an embodiment of the present invention is described in detail referring to FIG. 6.

When the moving robot 10 is stopped or moved, the omni-directional camera 11 captures an omni-directional image every certain period of time (600).

The captured omni-directional image is transmitted to the image processor 20. The image processor 20 may transform the omni-directional image, represented in the spherical coordinate system, to a panoramic image represented in the perspective coordinate system, as shown in FIG. 5, using a location transform LUT (610).

The panoramic image is transmitted from the image processor 20 to the controller 30 and memory 40. When the controller 30 inputs the currently transmitted panoramic image, i.e., a T image, it may also input/load a T−1 image from the memory 40 in 620, and then compare the T image with the T−1 image to determine whether there is a movement of the object, as will be detailed below.

After inputting the T−1 and T images, the controller 30 divides the T−1 image into blocks each of which is 20×20 pixels and then sets feature points in the respective blocks (630).

When the feature points are set in the respective blocks of the T−1 image at 630, the controller 30 may perform an optical flow matching operation to check to which location of the T image the respective feature points have been moved (640).

When the feature point of the T−1 image is matched with that of the T image through the optical flow matching operation at 640, the controller 30 calculates an SAD between the block in which the feature point of the T−1 image is placed and the blocks in which the feature point of the T image, matched with that of the T−1 image, is placed (650).

The controller 30 may check whether the SAD between the blocks exceeds the reference value to estimate the movement of a moving object. When the controller 30 detects a current block (T image) where the SAD exceeds the reference value, it estimates that the current block (T image) is a region where a moving object is moved (660).

In order to remove a background region, whose SAD is large due to the movement of the moving robot, from the movement region of a moving object estimated at 660, the controller 30 may determine whether the area of blocks between which the SAD exceeds the reference value, located in the unit area, is greater than the reference area (670).

When it is determined that the area of blocks between which the SAD exceeds the reference value, located in the unit area, is greater than the reference area at 670, the controller 30 may conclude that a moving object exists in the unit area and allows the moving robot 10 to move to the area or sound a siren (680). On the contrary, when it is determined that the area of blocks between which the SAD exceeds the reference value, located in the unit area, is less than the reference area at 670, the controller 30 terminates the control operation.

As is apparent from the above description, embodiments of the present invention remove a moving background captured by an omni-directional camera during the movement of the robot and thus precisely detects only an actually moving object.

Also, embodiments of the present invention can more precisely detect the movement of a moving object to be observed.

In addition to the above described embodiments, embodiments of the present invention can also be implemented through computer readable code/instructions in/on a medium, e.g., a computer readable medium, to control at least one processing element to implement any above described embodiment. The medium can correspond to any medium/media permitting the storing and/or transmission of the computer readable code.

The computer readable code can be recorded on a medium in a variety of ways, with examples of the medium including recording media, such as magnetic storage media (e.g., ROM, floppy disks, hard disks, etc.) and optical recording media (e.g., CD-ROMs, or DVDs). The computer readable code can also be transferred on transmission media such as media carrying or including carrier waves, as well as elements of the Internet, for example. Thus, the medium may be such a defined and measurable structure including or carrying a signal or information, such as a device carrying a bitstream, for example, according to embodiments of the present invention. The media may also be a distributed network, so that the computer readable code is stored/transferred and executed in a distributed fashion. Still further, as only an example, the processing element could include a processor or a computer processor, and processing elements may be distributed and/or included in a single device.

Although a few embodiments of the present invention have been shown and described, it would be appreciated by those skilled in the art that changes may be made in these embodiments without departing from the principles and spirit of the invention, the scope of which is defined in the claims and their equivalents.

What is claimed is:

1. A moving object detecting method of a moving robot comprising:
transforming an omni-directional image captured in the moving robot to a panoramic image;
comparing the panoramic image with a previous panoramic image and estimating a movement region of the moving object based on the comparison; and
recognizing that a movement of the moving object exists in the estimated movement region when the area of the estimated movement region exceeds a reference area.

2. The method as set forth in claim 1, wherein the comparing the panoramic image with a previous panoramic image comprises optical flow matching.

3. The method as set forth in claim 2, wherein the optical flow matching comprises:
dividing the previous panoramic image into a plurality of blocks;
setting feature points in the plurality of blocks; and
determining which location of the panoramic image the feature points are moved.

4. The method as set forth in claim 3, wherein the feature point is the darkest pixels of the corner pixels of the blocks.

5. The method as set forth in claim 2, further comprising:
calculating a sum of absolute difference (SAD) between the blocks matched by the optical flow matching.

6. The method as set forth in claim 5, further comprising:
estimating a block to be a movement region of a moving object when the SAD is greater than a reference value.

7. The method as set forth in claim 1, wherein the reference area is proportional to the size of a human body.

8. A moving object detecting method of a moving robot comprising:
transforming a plurality of omni-directional images captured in the moving robot to a plurality of panoramic images;
comparing the plurality of panoramic images with each other and discovering a block from one of the plurality of panoramic images, wherein the block is matched with a block of another panoramic image;
calculating an SAD between the matched blocks; and
detecting a moving object using the calculated SAD.

9. The method as set forth in claim 8, wherein the plurality of omni-directional images are two successive images.

10. The method as set forth in claim 8, further comprising:
determining that the moving object exists in a unit area, when an area of blocks located in the unit area and between which the SAD is greater than a reference value, exceeds a reference area.

11. The method as set forth in claim 10, wherein the reference area is proportional to the size of the moving object.

12. The method as set forth in claim 11, wherein the moving object includes a human body.

13. A moving robot comprising:
an image processor transforming an omni-directional image to a panoramic image;
a memory storing the panoramic image; and
a controller comparing the panoramic image transformed in the image processor with a panoramic image previously stored in the memory, estimating a movement region of a moving object based on the comparison, and determining that the moving object exists in the estimated movement region when an area of the estimated movement region exceeds a reference area.

14. The moving robot as set forth in claim 13, wherein the controller compares the panoramic image transformed in the image processor with a panoramic image previously stored in the memory using optical flow matching.

15. The moving robot as set forth in claim 13, wherein the reference area is proportional to the size of a moving object to be detected.

16. The moving robot set forth in claim 13 wherein the reference area is set within the controller.

17. The moving robot set forth in claim 13 wherein the panoramic image and the previous panoramic image are taken from a motion sequence where the robot has moved both within a plane and rotationally.

18. The moving robot set forth in claim 13 wherein the controller uses a reference SAD value in comparing.

19. A motion detection method comprising:
receiving a current panoramic image and a previous panoramic image;
matching blocks between the current panoramic image and the previous panoramic image;
acquiring an SAD for each of the matching blocks;
maintaining a reference SAD; and
determining motion based on a whether the SAD of a matched block meets the value of a reference SAD.

20. The motion detection method set forth in claim 19 wherein the matching is performed by optical flow matching.

21. The motion detection method set forth in claim 19 wherein the maintaining is performed by updating the reference SAD value to be a SAD value of a background shared by the current panoramic image and the previous panoramic image.

22. A computer readable recording medium having recorded thereon a computer program for executing the motion detection method set forth in claim 19.
